(19) United States
(12) Patent Application Publication
(10) Pub. No.: US 2016/0185008 A1
(43) Pub. Date: Jun. 30, 2016

(54) WAX-BIOCIDE WOOD TREATMENT

(71) Applicant: Rohm and Haas Company, Philadelphia, PA (US)

(72) Inventors: John W. Ashmore, Lansdale, PA (US); David M. Laganella, Swedesboro, NJ (US)

(21) Appl. No.: 15/064,119

(22) Filed: Mar. 8, 2016

Related U.S. Application Data
(62) Division of application No. 14/395,106, filed on Oct. 17, 2014.
(60) Provisional application No. 61/625,939, filed on Apr. 18, 2012.

(51) Int. Cl. B27K 3/08; A01N 25/30; B27K 3/34; C09D 191/06; B27K 3/00; A01N 43/80; C09D 5/14

(52) U.S. Cl. CPC B27K 3/08; A01N 43/80; A01N 25/30; C09D 5/14; C09D 191/06; B27K 3/005; B27K 3/007; B27K 3/343

(57) ABSTRACT

A method of achieving greater penetration of organic wood preservative into wood is provided.

Use of polymers, waxes and biocides in organic solvents to treat wood has been reported, for example in U.S. Pat. No. 7,297,193, which discloses treatment of wood with an aqueous composition comprising paraffin wax having melting point of 45° C. to 75° C., a nonionic surfactant, and an organic wood preservative. However, methods for treating wood using compositions that contain wax of melting point higher than 75° C. are desirable. The ability to treat wood using wax of melting point higher than 75° C. would allow the user to employ a wax that had one or more desirable trait that is not available in waxes of melting point of 75° C. and below. Such traits include, for example, improved water repellency over time and lower cost.

The problem addressed by this invention is the need for a method of treating wood with biocides and waxes of melting point above 75° C. in an aqueous formulation to enhance penetration of biocide into the wood, and a method for stabilizing the aqueous wood treatment formulation.

The following is a statement of the invention.

An aspect of the present invention is a method of achieving greater penetration of organic wood preservative into wood, the method comprising:

contacting the wood with an aqueous composition comprising
(a) a wax having melting point higher than 75° C. and an average particle size no greater than 1 micron; and
(b) greater than 0.08% by weight based on the weight of said aqueous composition, of a nonionic surfactant having the formula

R—OCH₂CH₂O_{X}H

wherein R is an aliphatic group having 10 to 16 carbon atoms; wherein the average value of x is 4.5 to 5.5;
(c) one or more organic wood preservative; and
(d) one or more oils wherein the amount of said oil is 0.02% to 2% by weight based on the weight of said aqueous composition.

The following is a detailed description of the invention.

All percentages and ppm values are by weight, and are on the basis of total weight of the treatment mixture, unless otherwise indicated

As used herein, and aqueous composition contains a continuous liquid medium, herein called the aqueous medium. The aqueous medium contains 75% or more water by weight based on the weight of the aqueous medium.

When it is said herein that the aqueous composition is substantially free of some material, it is meant that either that the material is entirely absent or else, if the material is present, it is present in an amount smaller than 0.01% by weight based on the weight of the aqueous composition.

Organic wood preservatives are biocides or insecticides. Organic wood preservatives do not contain metals, except as trace impurities. By trace impurities it is meant less than 0.001% by weight, based on the weight of the organic wood preservative. Preferred organic wood preservatives are tebuconazole, propiconazole, cypriconazole, amical, 3-iodo-2-propynylbutylcarbamate, 2-(thiocyanomethylthio)-benzothiazole, quaternary biocides, chlorothalonil, cypermethrin, permethrin, imidacloprid, thiacloprid, isothiazolones, and mixtures thereof. The wood preservative preferably includes one or more biocide. Preferred biocides are isothiazolone biocides. Preferred isothiazolone biocides are 4,5-dichloro-2-n-octyl-4-isothiazoline-3-one; 2-n-octyl-4-isothiazolin-3-one; 5-chloro-2-methyl-4-isothiazolin-3-one; 2-methyl-4-isothiazolin-3-one; 1,2-benzisothiazolin-3-one; n-butyl-1,2-benzisothiazolin-3-one; other halogenated isothiazolones, and mixtures thereof. Preferred isothiazolone biocides are halogenated isothiazolones. Preferred halogenated isothiazolone biocides preferably comprise one or more chlorinated isothiazolin-3-one; more preferably 4,5-dichloro-2-n-octyl-4-isothiazolin-3-one (“DCOIT”).

Waxes suitable for use in the present invention preferably have a melting point (sometimes reported as a softening point) greater than 75° C. Preferably, the melting point is 80° C. or greater; more preferably 110° C. or greater; more preferably 120° C. or greater. Preferably, the melting point is 250° C. or less; more preferably 200° C. or less.

Preferred waxes are plant waxes, vegetal waxes, mineral waxes, and synthetic waxes. More preferred waxes comprise carnauba wax, polyolefin wax, or a mixture thereof.

Polyolefin wax contains a group of 50 or more carbon atoms connected to each other by single bonds. In preferred polyolefin waxes, the group of carbon atoms that are connected to each other contains 75 or more carbon atoms; more preferably 100 or more carbon atoms. The arrangement of carbon atoms may be linear, branched, cyclic, or a combination thereof.

Preferred polyolefin waxes have number-average molecular weight of 1,000 or more; more preferably 2,000 or more. Preferred polyolefin waxes have number-average molecular weight of 10,000 or less; more preferably 5,000 or less.

Preferred polyolefin waxes are made by polymerization of one or more olefin monomer, optionally with one or more comonomer. Comonomers are molecules that are not olefins that have a double bond and are capable of copolymerization with an olefin. Suitable comonomers are, for example, vinyl acetate, methyl acrylate, and butyl acrylate. Olefin monomers are olefin molecules capable of polymerization. Preferred olefin monomers are ethylene, propylene, and butylene; more preferred is ethylene. Preferred polyolefin wax is polyethylene; more preferred is high density polyethylene. More than one wax may be included in the wood treatment mixture.

The aqueous composition used to treat wood contains wax in the form of particles dispersed in the aqueous medium. Preferably, the wax has an average particle size no greater than 500 nm, alternatively no greater than 250 nm, alternatively no greater than 120 nm, alternatively no greater than 110 nm, alternatively no greater than 100 nm Preferably, the wax has an average particle size no smaller than 20 nm.

Preferably, the wax solids content of the composition is from 0.5% to 5%, more preferably from 1% to 3%. Preferably, the wax solids to biocide ratio is from 1:1 to 150:1, more preferably from 3:1 to 70:1.

The aqueous composition used to treat wood contains one or more nonionic surfactant (b) of the formula

R—OCH₂CH₂O_{X}H

where R is an aliphatic group having 10 to 16 carbon atoms, and where the average value of x is 4.5 to 5.5. Preferably R—O— is the residue of a secondary alcohol. Preferably R is alkyl. Preferably surfactant (b) contains a mixture of compounds in which R is an alkyl group having 12 to 14 carbon atoms. Preferably the average value of x is 4.8 to 5.2.

The amount of surfactant (b) in the aqueous composition used to treat wood is 0.08% or more by weight based on the weight of the aqueous composition. Preferably, the amount of surfactant (b), by weight based on the weight of the aqueous composition, is 0.1% or more; more preferably 0.12% or more. Preferably, the amount of surfactant (b), by weight based on the weight of the aqueous composition, is 3% or less; more preferably 1% or less; more preferably 0.5% or less; more preferably 0.3% or less.

The aqueous composition used to treat wood preferably contains one or more surfactant in addition to surfactant (b). Preferably, surfactants other than surfactant (b) are either anionic surfactants or nonionic surfactants or a mixture thereof.

The aqueous composition used to treat wood preferably contains from 300 ppm to 5,000 ppm halogenated isothiazolone biocide, more preferably from 400 ppm to 4,000 ppm, and most preferably from 500 ppm to 2,000 ppm.

The aqueous composition used to treat wood preferably contains a non-aqueous solvent. Solvents are liquid at 25° C. The molecule of a solvent does not contain any one chemical group that has 10 or more carbon atoms connected to each other in a line. Preferably, the amount of solvent is from 0.01% to 2%, more preferably from 0.02% to 1%, and most preferably from 0.04% to 0.5%. Preferable solvents include ester and ether solvents having a boiling point of at least 150° C., and preferably a flash point of at least 60° C. Preferably, the aqueous composition is substantially free of other solvents. Preferred solvents include glycols, and their ethers and esters; more preferred are TEXANOL (2,2,4-trimethyl-1,3-pentanediol, mono-isobutyrate ester; available from Eastman Co., Kingsport Tenn.), DOWANOL DPM (dipropylene glycol, methyl ether; available from Dow Chemical Co.), DOWANOL PPH (propylene glycol phenyl ether), propylene glycol (PG), dipropylene glycol, dipropylene glycol butyl ether, dipropylene glycol propyl ether, alkyl ethers of tripropylene glycol (such as tripropylene glycol methyl ether), alkyl ethers of ethylene glycol (such as ethylene glycol monobutyl ether), and alkyl ethers of diethylene glycol (such as diethylene glycol monobutyl ether).

The aqueous composition used to treat wood preferably contains one or more oil. Oils are liquid at 25° C. The molecule of an oil contains at least one chemical group that has 10 or more carbon atoms connected to each other in a line. Preferred oils are mineral oils and fatty acid derivatives. Mineral oil is separated from petroleum. Fatty acid derivatives include fatty acids, amides of fatty acids (including N-substituted amides), and esters of fatty acids (including mono-, di-, and triglycerides). Preferred fatty acid derivatives are monoesters of fatty acids; more preferred are propylene glycol monoesters of fatty acids. Preferred fatty acid derivatives are mixtures of esters that contain of two or more fatty acids; more preferred are mixtures that contain esters of oleic and linoleic acids; more preferred are mixtures in which, when the fatty acid residues are considered, the amount of the sum of oleic and linoleic acids is 60% or more by weight, based on the weight of the sum of all the fatty acid residues in the mixture of fatty acid derivatives.

The amount of oil, by weight based on the weight of the aqueous composition used to treat wood, is 0.02% or more; more preferably 0.05% or more; more preferably 1% or more. The amount of oil, by weight based on the weight of the aqueous composition used to treat wood, is 2% or less; more preferably 1% or less; more preferably 0.5% or less.

The aqueous compositions used in the present invention may optionally contain additional components including but not limited to stabilizers, dyes, other wood biocides, fungicides and insecticides, antioxidants, metal chelators, radical scavengers, etc. Stabilizers include, e.g., organic and inorganic UV stabilizers, such as, copper oxide or other copper salts or complexes that resist leaching; zinc oxide; iron salts, iron oxide, iron complexes, transparent iron oxide and nanoparticle iron oxide; titanium dioxide; benzophenone and substituted benzophenones; cinnamic acid and its esters and amides; substituted triazines, such as triphenyl triazine and substituted phenyl triazine UV absorbers, benzotriazole and substituted benzotriazole UV absorbers; hindered amine light stabilizers, used individually or in combination. Other wood biocides, fungicides and insecticides include, e.g., those listed in U.S. Pat. No. 6,610,282, e.g., imidachloprid and permethrin. Antioxidants include any commercially available antioxidant compounds, e.g., phosphite antioxidants such as IRGAFOS; lactone antioxidants; phenolic antioxidants such as BHT; ascorbic acid; and IRGANOX and the like. Metal chelators include, e.g., EDTA, NTA, 1,10-phenanthroline, ACUMER 3100, DEQUEST, TAMOL 731, tripolyphosphate and other inorganic and organic compounds and polymers useful in chelating or dispersing metal salts. Radical scavengers include, e.g., TEMPO.

Treatment of wood is performed by contacting the wood with the aqueous composition described herein, preferably under conditions specified in AWPA Standards T1-05, N1-04, N2-04 and references cited therein.

In one preferred embodiment, the treatment mixture is formulated as a ready-to-use emulsion in a single container, with 0.5-5% wax solids, 400-4000 ppm DCOIT, 0-5% surfactant(s), 0-0.5% non-aqueous solvent, and the remainder water.

### EXAMPLES

Tergitol™ 15-S-5 (herein called “NS1”) is a secondary alcohol ethoxylate nonionic surfactant from The Dow Chemical Company, having average value of 5.0 ethylene oxide groups per molecule and alkyl group of 12 to 14 carbon atoms.

### Example 1

The wax emulsions used were commercial wax emulsions as follows. The “emulsifier” in Table 1 is the type of emulsifier contained in the commercial wax emulsion.

TABLE 1
Wax emulsions

| Wax | | | | |
|---|---|---|---|---|
| Number | Type | Melting Point(s) | Particle Size | Emulsifier |
| W1 | paraffin/ | 60° C. and 110° C. | 115 nm | anionic |
| | polyethylene | | | |
| W2 | carnauba | 85° C. | 150 nm | anionic |
| W3 | polyethylene | 140° C. | 40 nm | anionic |
| W4 | polyethylene | 112° C. | 45 nm | unknown |

### Example 2

### Preparation of the Wood Treatment Mixture was as Follows

One gallon (3.8 L) of the treatment mixture was prepared by diluting a commercial wax emulsion with tap water to the total weight (minus the weight of biocide formulation to be added) with stirring for 20 minutes at 300 rpm.

To the well stirred mixture was slowly added sufficient biocide formulation to produce a final concentration of 800 ppm DCOIT. The mixture was stirred for 30 minutes. If oil was used, an oil emulsion was then added to the mixture in an amount sufficient to give 0.2% by weight oil in the treatment mixture, based on the weight of the treatment mixture. The resulting mixture was then used to treat wood.

The biocide formulation was made as follows: 25 parts by weight of DCOIT and 25 parts by weight of Tergitol™ 15-S-5 were added to 50 parts by weight of solvent. The solvent was a mixture of equal parts by weight of water and dipropylene glycol methyl ether.

The oil emulsions were made as follows: 6 parts by weight of oil, 1.2 parts by weight of surfactant NS1, and 120 parts by weight of water were mixed to form an emulsion.

### Example 3

### Procedure to Treat Wood was as Follows

Two 5.5×5.5×1 inch (14×14×2.5 cm) pieces of Southern Yellow Pine were loaded into a 2 L pressure vessel equipment with an inlet tube, gas/vacuum inlet, pressure sensors, dropout valve and level indicators. The vessel was sealed and the pressure was reduced to 26-27 inches of Hg (88-91 kPa) and held for 15-20 minutes. The vacuum was turned off and sufficient treatment mixture was drawn into the vessel to completely cover the wood. The vessel was pressurized to approximately 150 psig (1136 kPa). A pump was used to maintain the liquid level above the wood. When no more treatment mixture was taken up by the wood, the pressure was released and the vessel drained via the dropout valve. A vacuum was pulled on the vessel again for approximately 5 minutes, the vessel again drained, and then the wood removed (full cell with final vacuum treatment) to partially remove some of the surface moisture from the treated wood.

### Example 4

### Analysis of the Treatment Mixture and Wood was as Follows

A 2 g sample of the as is treatment mixture was analyzed for DCOIT by HPLC. Each treatment mixture was found to contain 800 ppm of DCOIT.

Once the wood sample had dried to a constant weight, placed in a constant temperature and humidity room, it was analyzed for DCOIT content. Using a drill press containing a ¾ inch (19 mm) Forstner bit, three holes were drilled in the wood. The location of the holes were on one face, at least ¼ inch (6.4 mm) from the sides and ends and where the grain angle was the most vertical between the two faces. One millimeter sections from each hole at depths of 1, 3 and 10 millimeters were collected, combined and analyzed for DCOIT.

A known weight of wood shaving sample was extracted in methanol by sonication for two hours. The extract was then allowed to cool to room temperature. The cooled extract was analyzed by a reverse phase high performance liquid chromatography. The DCOIT was separated from sample matrix using a 25 cm C18 column using water and methanol as mobile phase. The DCOIT was detected using ultraviolet detector set at 280 nanometers. Concentration of DCOIT in sample was determined by comparing peak area of the DCOIT peak in sample with the DCOIT peak in a standard solution using an external standard calculation method.

### Example 5

The formulations used for treating wood are shown in Table 2 below. MO is mineral oil, and RC is RC™ oil from Archer. Samples having “Comp” in the number are Comparative Examples. When oil was added, the amount was 0.2% by weight based on the weight of the formulation.

TABLE 2
Formulations

| Number | NS1 % | oil | Wax |
|---|---|---|---|
| 3Comp | 0.08 | none | W1 |
| 11a | 0.13 | none | W1 |
| 11b | 0.17 | MO | W1 |
| 11c | 0.17 | RC | W1 |
| 2Comp | 0.08 | none | W2 |
| 12a | 0.13 | none | W2 |
| 12b | 0.17 | MO | W2 |
| 12c | 0.17 | RC | W2 |
| 6Comp | 0.08 | none | W3 |
| 13a | 0.13 | none | W3 |
| 13b | 0.17 | MO | W3 |
| 13c | 0.17 | RC | W3 |
| 14zComp | 0.08 | none | W4 |
| 14a | 0.13 | none | W4 |
| 14b | 0.17 | MO | W4 |
| 14c | 0.17 | RC | W4 |

### Example 6

The results of the testing described in Examples 1-5 was as follows. Table 3 presents penetration data for DCOIT in wood in ppm at depths of 1, 3 and 10 mm; and the stability (S=stable, U=unstable) of the treatment mixture before/during treatment of the wood. Desirable characteristics are stability of the formulation, a high amount of DCOIT penetrating to 10 mm depth, and a relatively small gradient of DCOIT concentration (the ratio of DCOIT at 1 mm to DCOIT at 10 mm)

TABLE 3
Results

| | | | DCOIT at | DCOIT at | DCOIT at | |
|---|---|---|---|---|---|---|
| | | | 1 mm | 3 mm | 10 mm | |
| No. | Wax | Stab. | (ppm) | (ppm) | (ppm) | gradient |
| 3Comp | W1 | S/U | 441 | 162 | 79 | 5.6 |
| 11a | W1 | S/S | 1916 | 1024 | 425 | 4.5 |
| 11b | W1 | S/S | 1296 | 785 | 431 | 3.0 |
| 11c | W1 | S/S | 1044 | 727 | 614 | 1.7 |
| 2Comp | W2 | S/S | 376 | 517 | 493 | 0.8 |
| 12a | W2 | S/S | 1187 | 845 | 682 | 1.7 |
| 12b | W2 | S/S | 901 | 619 | 554 | 1.6 |
| 12c | W2 | S/S | 800 | 751 | 662 | 1.2 |
| 6Comp | W3 | S/U | | | | |
| 13a | W3 | S/U | | | | |
| 13b | W3 | S/S | 1322 | 928 | 383 | 3.5 |
| 13c | W3 | S/S | 966 | 880 | 533 | 1.8 |
| 14zComp | W4 | U | | | | |
| 14a | W4 | S/S | 992 | 697 | 429 | 2.3 |
| 14b | W4 | S/S | 676 | 556 | 454 | 1.5 |
| 14c | W4 | S/S | 857 | 708 | 574 | 1.5 |

Penetration studies were not performed on samples 3Comp, 2Comp, 6Comp, 13a, and 14zComp, because these formulations were not stable. For wax W1, increasing the level of NS1 surfactant improved the stability and the DCOIT penetration at 10 mm; and addition of oil further improved the DCOIT penetration at 10 mm. For wax W2, increasing the level of NS1 surfactant improved the stability and the DCOIT penetration at 10 mm; and addition of oil further improved the gradient. For wax W3, only the sample with both the increased level of NS1 and the presence of oil had both stability and acceptable penetration. For wax W4, increasing the level of NS1 surfactant improved the stability; and addition of oil further improved the DCOIT penetration at 10 mm.

### Example 7

### Other Oils

Using the same methods as Examples 1-7, formulations were made using other oils. These other oils were liquid at 25° C. Each oil was a polymer, as follows: homopolymer of n-butyl acrylate (BA); copolymer of 60 parts by weight BA and 40 parts by weight styrene; and copolymer of 40 parts by weight BA and 60 parts by weight styrene. Formulations made with each of these three oils was unstable during the treatment. Also, the third oil (40/60 BA/Styrene) was unstable prior to treatment.

### Example 8

### Retention of Water Repellency

Wood treated with paraffin wax has been observed under conditions in which it was exposed to weather. Paraffin wax is a hydrocarbon that has fewer than 30 carbon atoms per molecule. When the wood is freshly coated, the wood is waterproof. However, after a relatively short time, the wood is no longer waterproof. Also, wood treated with polyethylene wax has been observed under conditions in which it was exposed to weather. The wood treated with polyethylene wax remained waterproof for a longer time.

1. A method of achieving greater penetration of organic wood preservative into wood, the method comprising:
contacting the wood with an aqueous composition comprising
(a) a wax having melting point higher than 75° C. and an average particle size no greater than 1 micron; and
(b) greater than 0.08% by weight based on the weight of said aqueous composition, of a nonionic surfactant having the formula
R—OCH₂CH₂O_{X}H
wherein R is an aliphatic group having 10 to 16 carbon atoms; wherein the average value of x is 4.5 to 5.5;
(c) one or more organic wood preservative; and
(d) one or more oils wherein the amount of said oil is 0.02% to 2% by weight based on the weight of said aqueous composition.

2. The method of claim 1, wherein said organic wood preservative comprises a compound selected from the group consisting of tebuconazole, propiconazole, cypriconazole, 3-iodo-2-propynylbutylcarbamate, 2-(thiocyanomethylthio)-benzothiazole, quaternary biocides, chlorothalonil, cypermethrin, permethrin, imidacloprid, thiacloprid, isothiazolones, and mixtures thereof.

3. The method of claim 1, wherein said nonionic surfactant is a secondary alcohol ethoxylate.

4. The method of claim 1, wherein said wax comprises a polyethylene wax.

5. The method of claim 1, wherein said wax has melting point of 110° C. or greater.
